(19) United States
(12) Patent Application Publication
(10) Pub. No.: US 2026/0169448 A1
(43) Pub. Date: Jun. 18, 2026

(54) SYSTEM AND METHOD FOR SITE-SPECIFIC KNOWLEDGE PRESERVATION, VALIDATION, AND GOVERNANCE IN REGULATED INDUSTRIAL FACILITIES

(71) Applicant: Jae Kwang Park, VERONA, WI (US)

(72) Inventor: Jae Kwang Park, VERONA, WI (US)

(21) Appl. No.: 19/437,410

(22) Filed: Dec. 31, 2025

(51) Int. Cl. G05B 13/04; G05B 13/02

(52) U.S. Cl. CPC G05B 13/048; G05B 13/0265

(57) ABSTRACT

A Hybrid AI-Driven Expert System and Method are disclosed for preserving, validating, governing, and retiring site-specific operational knowledge in regulated industrial facilities. The system employs a dual-track architecture integrating a quantitative predictive optimization engine with a qualitative knowledge governance engine. Human-derived operational heuristics are adversarially validated against regulatory and safety standards and enforced as safety-dominant control constraints. A lifecycle management framework continuously updates heuristic reliability and automatically deprecates outdated logic upon asset modification (e.g., firmware updates), thereby preventing the persistence of Obsolete Operational Logic. The invention enables safe, transparent transition from human-operated to autonomous industrial control while preserving critical institutional expertise.

### CROSS REFERENCE TO RELATED PATENT APPLICATIONS

This application is a Continuation-in-Part (CIP) of, and claims priority to, U.S. patent application Ser. No. 18/414,566, Publication No. 2025/0231538, entitled “AI-Driven Optimization and Control of Aeration in Wastewater Treatment Plants in Real Time” (hereinafter “Patent #1”). The present application incorporates the predictive numerical outputs of Patent #1 as a subordinate quantitative optimization layer while introducing a novel knowledge governance architecture that formalizes, validates, enforces, and retires site-specific operational heuristics as safety-dominant constraints for autonomous and semi-autonomous industrial control.

### FIELD OF DISCLOSURE

The present disclosure relates generally to industrial process control and operational knowledge governance systems for regulated industrial facilities, including but not limited to wastewater treatment plants, drinking water facilities, power generation systems, manufacturing plants, and other critical infrastructure subject to regulatory compliance. More particularly, the disclosure relates to a Hybrid AI-Driven Expert System configured for digitizing undocumented human operational knowledge, validating such knowledge against regulatory and safety constraints, and enforcing validated site-specific heuristics as machine-governed control constraints within autonomous and semi-autonomous industrial control environments.

### BACKGROUND OF THE INVENTION

Regulated industrial sectors, including water and wastewater treatment, energy production, chemical processing, and manufacturing, are experiencing a sustained reduction in the availability of experienced operational personnel. As senior operators retire or exit the workforce, substantial amounts of site-specific operational knowledge-referred to herein as Local Heuristics—are lost. Such knowledge is frequently undocumented, informally transmitted, and derived from long-term interaction with specific equipment, process configurations, and environmental conditions, and is not adequately captured by conventional documentation practices.

Concurrently, industrial processes have become more complex and data-intensive. Modern facilities generate large volumes of real-time telemetry, alarms, and historical records that must be interpreted under time-critical conditions. With reduced staffing levels, operators may lack sufficient contextual knowledge or cognitive capacity to recognize early indicators of instability, allowing minor deviations to escalate into process upsets, regulatory non-compliance, or safety incidents.

Many facilities, therefore, operate primarily in a reactive manner, correcting deviations only after they occur. This operational mode is partly attributable to the absence of predictive tools capable of modeling nonlinear process behavior under changing operational and environmental conditions. To mitigate risk, operators often maintain conservative operating margins, which constrains achievable efficiency and results in increased energy consumption, chemical usage, and equipment wear.

Conventional supervisory control and data acquisition (SCADA) systems and programmable logic controllers (PLCs) rely on static, rule-based logic manually configured by engineers. While effective for deterministic control tasks, such systems adapt poorly to equipment aging, configuration changes, or evolving process conditions without manual reprogramming. In addition, these systems generally cannot ingest or reason over unstructured operational inputs, such as handwritten logs or voice-recorded shift notes, thereby creating information bottlenecks for already constrained personnel.

Informal operational practices and heuristics are often applied based on experience rather than formal validation. Existing control and knowledge systems typically lack automated mechanisms to assess whether such heuristics remain safe, compliant, or applicable following changes to equipment, firmware, regulatory requirements, or process configuration. As a result, outdated or unsafe Obsolete Operational Logic may persist undetected in regulated environments.

Accordingly, a technical need exists for systems capable of capturing site-specific operational knowledge, validating such knowledge against applicable safety and regulatory constraints, and integrating validated heuristics into industrial control decision-making processes. Such systems should augment existing control architectures, support predictive optimization, and prevent execution of obsolete or unsafe operational logic.

Although various technologies address aspects of industrial control, knowledge management, expert systems, or artificial intelligence, these approaches are typically deployed in isolation. Known solutions emphasize information storage or advisory recommendations but do not provide an integrated framework for validating, governing, and lifecycle-managing site-specific heuristics within live industrial control environments.

Consequently, there is a technical need for a Hybrid AI-Driven Expert System capable of integrating predictive analytics, contextual reasoning, and validated human operational knowledge within a governance architecture that enforces safety, compliance, and lifecycle management, thereby enabling more resilient, efficient, and reliable operation of regulated industrial facilities under evolving workforce and process conditions.

### SUMMARY OF THE INVENTION

The present invention addresses technical limitations in existing industrial control and artificial intelligence systems arising from (i) deterministic optimization models that fail to account for site-specific qualitative operational constraints, (ii) probabilistic output errors generated by semantic or language-based machine learning models, and (iii) degradation of operational knowledge validity resulting from changes in physical assets, control configurations, or regulatory conditions.

In one embodiment, the invention provides a computer-implemented system for governing operation of physical equipment in a regulated industrial facility. The system comprises a predictive optimization module configured to generate executable control actions based on real-time sensor data, and a governance module configured to validate human-derived operational heuristics against encoded safety and regulatory constraints. The governance module constrains, modifies, or blocks transmission of executable control actions to an industrial control system when a validated heuristic indicates a safety or compliance condition, thereby preventing execution of unsafe or non-compliant operating states.

The system further includes a semantic governance architecture that separates numerical optimization from contextual constraint generation. A qualitative governance track utilizes one or more machine learning models trained on curated regulatory and operational datasets to generate non-executable semantic constraints, historical context, or operational justifications. These outputs are applied to bound executable control actions without issuing direct control commands to physical equipment, thereby mitigating probabilistic output errors while preserving deterministic control behavior.

In some embodiments, the system incorporates lifecycle-aware governance mechanisms that automatically invalidate or re-evaluate stored operational heuristics in response to detected changes in physical equipment, firmware versions, control configurations, or regulatory requirements. By associating operational heuristics with asset compatibility identifiers and enforcing revalidation upon asset modification, the system prevents execution of obsolete or unsafe operational logic.

Through the integration of governance-based constraint enforcement, probabilistic output validation, and lifecycle-aware knowledge management, the present invention improves the technical safety, reliability, and compliance of industrial control systems operating under complex and evolving conditions.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 is a block diagram of the governance-centric Hybrid AI-Driven Expert System.

FIG. 2 is a functional diagram of the knowledge ingestion and adversarial validation pipeline.

FIG. 3 is a schematic diagram of the dual-track hybrid intelligence architecture.

FIG. 4 is a logical diagram of decision synthesis and governance enforcement.

FIG. 5 is a flow diagram of the operational control cycle.

FIG. 6 is a diagram of heuristic lifecycle management and Obsolete Operational Logic prevention.

FIG. 7 is a diagram of the performance-based trust updating loop.

FIG. 8 is a block diagram of the federated knowledge network.

FIG. 9 is a conceptual diagram of semantic conflict resolution.

FIG. 10 is a flowchart of the governance-driven operational method.

FIG. 11 is a diagram of proactive SCADA alarm integration.

FIG. 12 is a diagram of the operator dashboard.

FIG. 13 is a diagram of the citation and traceability interface.

FIG. 14 is a block diagram of the Causal Analysis and Explanation architecture.

FIG. 15 is a diagram of the reinforcement learning loop.

FIG. 16 is a block diagram of the distributed computing and deployment architecture.

### DETAILED DESCRIPTION OF THE INVENTION

### Definitions

Regulated Industrial Facility: A physical site subject to federal or state compliance mandates [e.g., National Pollutant Discharge Elimination System (NPDES), Occupational Safety and Health Administration (OSHA), Federal Energy Regulatory Commission (FERC)]. where operations are managed via industrial control systems (e.g., SCADA), including wastewater treatment, power generation, and chemical processing facilities.

Hybrid AI-Driven Expert System: A dual-track architecture configured to process structured quantitative telemetry (e.g., sensor data) and unstructured qualitative heuristics (e.g., human knowledge) in parallel to generate control recommendations that are mathematically optimized while being bounded by semantic safety constraints.

Artificial Intelligence (AI) Model: Computational algorithms configured to automate ingestion, validation, retrieval, or analysis of domain-specific knowledge using adaptive or learned logic.

Retrieval-Augmented Generation (RAG): A generative AI architecture that optimizes output accuracy by referencing an authoritative external knowledge base (vector retrieval, knowledge graphs) to ground outputs in verifiable evidence.

International Industry Standard Dictionary: A dynamic vector database of domain-specific technical papers, journals, equipment manuals, and standards.

Local Heuristics: Context-dependent operational logic derived from human experience (e.g., uncodified knowledge, tacit insight) rather than formal documentation.

Local Wisdom Dictionary: A site-specific vector database comprising validated heuristic rules, logbook entries, operational history, and jurisdiction-specific certification requirements.

Federated Knowledge Interface: A secure communication layer for exchanging anonymized operational heuristics between facilities based on matching equipment specifications (e.g., asset hash).

Adversarial Validation: An automated process where a secondary logic unit audits primary outputs for safety or compliance prior to execution, specifically configured to prevent AI hallucinations or “black box” errors.

Causal Analysis and Explanation Logic: Computational processes mapping relationships between input variables and model predictions, including feature importance, causal inference, and counterfactual simulations.

Obsolete Operational Logic: Operational heuristics rendered unsafe or inaccurate by changes in underlying physical assets (hardware/firmware) or regulatory environments.

### Description

The following detailed description is exemplary in nature and is provided to enable a person skilled in the art to make and use the invention. The description emphasizes the conceptual flow of the invention and the functional role of each illustrated embodiment and is not intended to limit the scope of the claims. No expressed or implied theory is intended to be binding.

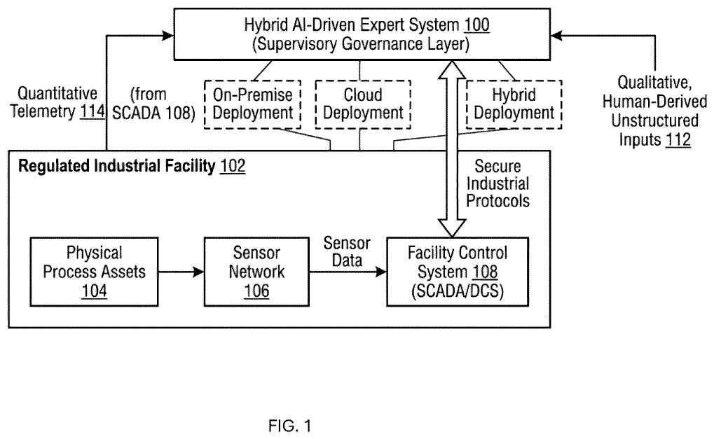

Governance-Centric Hybrid AI-Driven Expert System Overview (FIG. 1): Referring to FIG. 1, the invention is implemented as a Hybrid AI-Driven Expert System 100 operating as a supervisory governance layer within a regulated industrial facility 102. The facility includes physical process assets 104 monitored by a sensor network 106 measuring operational variables. Sensor data are transmitted to a facility control system 108, such as a supervisory control and data acquisition (SCADA) system or distributed control system (DCS). Unlike conventional architectures in which the SCADA system 108 serves as the sole logic controller, the Hybrid AI-Driven Expert System 100 provides supervisory governance oversight. The system 100 may be deployed on-premise, in the cloud, or in a hybrid configuration and is communicatively coupled to the SCADA system 108 via secure industrial protocols. The system ingests quantitative telemetry 114 as a first processing stream and qualitative, human-derived unstructured inputs 112 as a second processing stream.

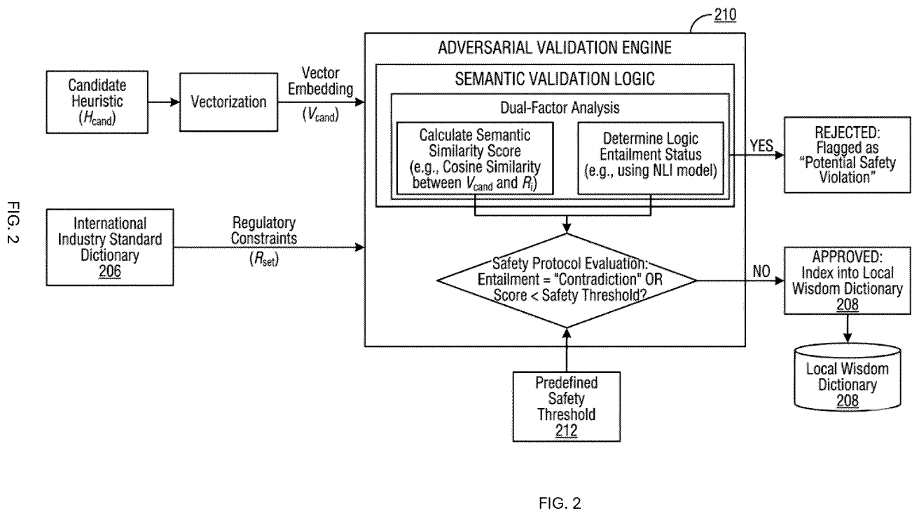

Knowledge Ingestion and Validation Pipeline (FIG. 2): Referring to FIG. 2, the system includes a Knowledge Ingestion and Validation Pipeline 200 configured to transform unstructured inputs 112 into validated, machine-governed knowledge assets. Unstructured inputs 112, such as handwritten logbooks, voice-recorded shift notes, and maintenance reports, are captured through a user interface 110 and digitized by a Digitization Module 202 using optical character recognition and speech-to-text techniques. Digitized content is processed by a Vectorization Engine 204, which converts semantic content into machine-searchable vector embeddings. These embeddings are evaluated using a Dual-Dictionary Architecture comprising an International Industry Standard Dictionary 206 and a Local Wisdom Dictionary 208. The International Industry Standard Dictionary 206 contains machine-readable representations of regulatory requirements, equipment safety limits, and engineering best practices. The Local Wisdom Dictionary 208 stores validated heuristics 214 derived from operator experience.

Enablement of Validation Logic: Before any heuristic is indexed into the Local Wisdom Dictionary 208, it must pass through an Adversarial Validation Engine 210, which evaluates candidate heuristics against safety, regulatory, and process-stability criteria. In operation, the engine executes a semantic validation logic wherein a received candidate heuristic (H_{cand}) is first converted into a machine-readable vector embedding (V_{cand}). The system then retrieves a set of applicable Regulatory Constraints (Rₛₑₜ) from the International Industry Standard Dictionary 206. The engine iterates through each constraint (Rᵢ) in the set to perform a dual-factor analysis: calculating a semantic similarity score (e.g., via Cosine Similarity between V_{cand} and Rᵢ) and determining a logic entailment status (e.g., using a Natural Language Inference model). The system evaluates these metrics against a safety protocol; if the entailment determines a logical “Contradiction” or if the semantic similarity score falls below a predefined safety threshold, the candidate heuristic is rejected and flagged as a “Potential Safety Violation.” Conversely, if the heuristic clears these checks, it is approved and indexed into the Local Wisdom Dictionary 208. This logic ensures only heuristics exceeding a predefined safety threshold 212 are admitted, thereby preventing unsafe or outdated uncodified knowledge from influencing control logic.

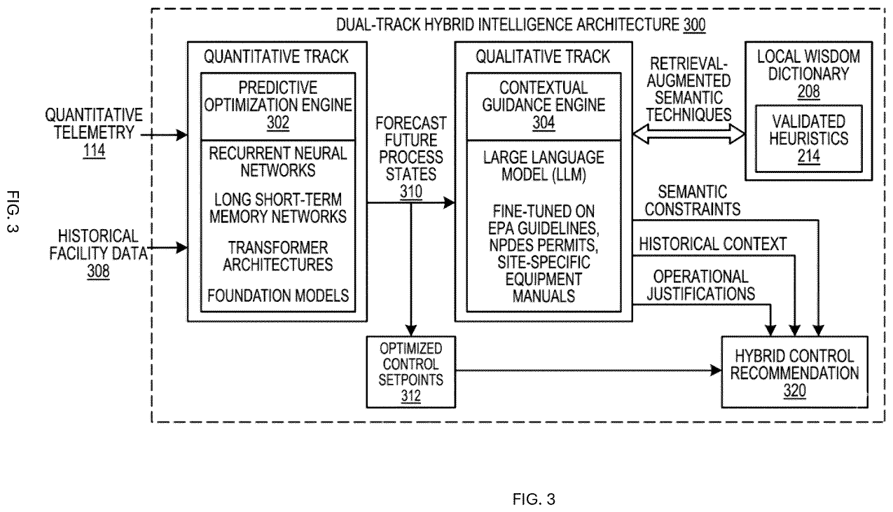

Dual-Track Hybrid Intelligence Architecture (FIG. 3): Referring to FIG. 3, the invention employs a Dual-Track Hybrid Architecture 300 that separates numerical optimization from contextual governance. A Quantitative Track, implemented by a Predictive Optimization Engine 302, utilizes the real-time control methodologies and numerical forecasting algorithms disclosed in Patent #1 to ingest quantitative telemetry 114 and historical facility data 308 to forecast future process states 310 and compute optimized control setpoints 312. This engine employs machine learning models such as recurrent neural networks, long short-term memory networks, Transformer architectures, or Foundation Models. Operating in parallel, a Qualitative Track, implemented by a Contextual Guidance Engine 304, interprets the forecasted process state 310 and retrieves relevant validated heuristics 214 from the Local Wisdom Dictionary 208 using retrieval-augmented semantic techniques. The Contextual Guidance Engine 304 utilizes one or more machine learning models trained or fine-tuned on curated datasets, including regulatory documents and equipment manuals, to generate non-executable semantic constraints that are applied to bound executable control actions transmitted to industrial control systems. The qualitative track does not generate executable control commands. Instead, it produces semantic constraints, historical context, and operational justifications applicable to the optimized control setpoints 312, which are subsequently synthesized to form a Hybrid Control Recommendation 320.

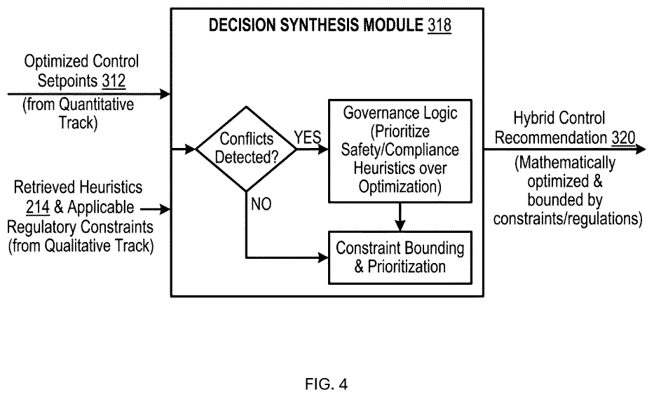

Decision Synthesis and Governance Enforcement (FIG. 4): Referring to FIG. 4, outputs from the quantitative and qualitative tracks converge at a Decision Synthesis Module 318. This module evaluates optimized control setpoints 312 against retrieved heuristics 214 and applicable regulatory constraints. When conflicts are detected, governance logic is applied to prioritize validated safety and compliance heuristics over mathematical optimization. The result of this process is the Hybrid Control Recommendation 320, which is mathematically optimized while remaining bounded by site-specific operational constraints and regulatory requirements. The Governance Module may comprise one or more submodules, including a Decision Synthesis Module and a Contextual Guidance Engine.

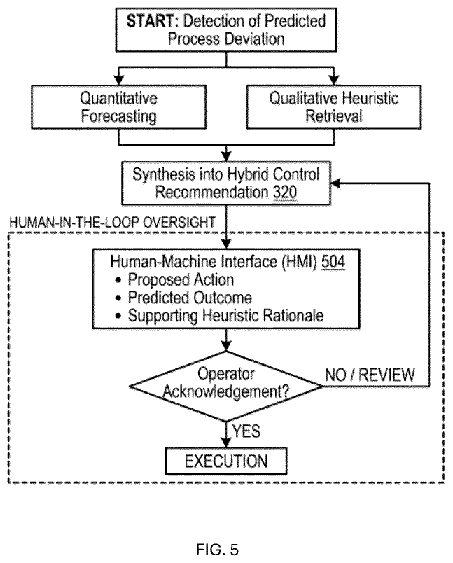

Operational Control Flow and Human Oversight (FIG. 5): Referring to FIG. 5, the operational control flow begins with the detection of a predicted process deviation. Quantitative forecasting and qualitative heuristic retrieval occur in parallel, followed by synthesis into a hybrid control recommendation 320. The recommendation is presented to an operator via a human-machine interface (HMI) 504, displaying the proposed action, predicted outcome, and supporting heuristic rationale. Operator acknowledgement is required prior to execution, ensuring human-in-the-loop oversight while maintaining autonomous assistance.

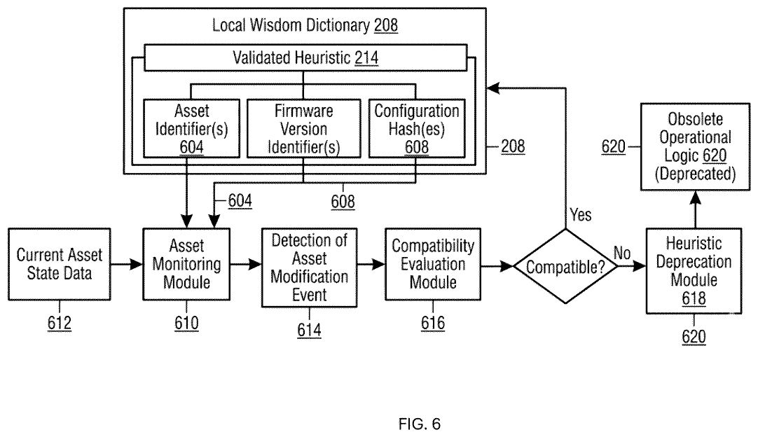

Heuristic Lifecycle Management and Obsolete Logic Prevention (FIG. 6): Referring to FIG. 6, a heuristic lifecycle management framework 600 is illustrated. Each validated heuristic 214 stored in the Local Wisdom Dictionary 208 is associated with one or more asset identifiers 604, firmware version identifiers 606, and configuration hashes 608 corresponding to physical process assets 104. An asset monitoring module 610 continuously evaluates current asset state data 612 against stored identifiers 604-608. Upon detection of an asset modification event 614, including hardware replacement, firmware update, or configuration change, a compatibility evaluation module 616 determines whether the associated validated heuristic 214 remains valid. Heuristics determined to be incompatible are automatically deprecated by a heuristic deprecation module 618, thereby preventing persistence of Obsolete Operational Logic 620 after system modifications.

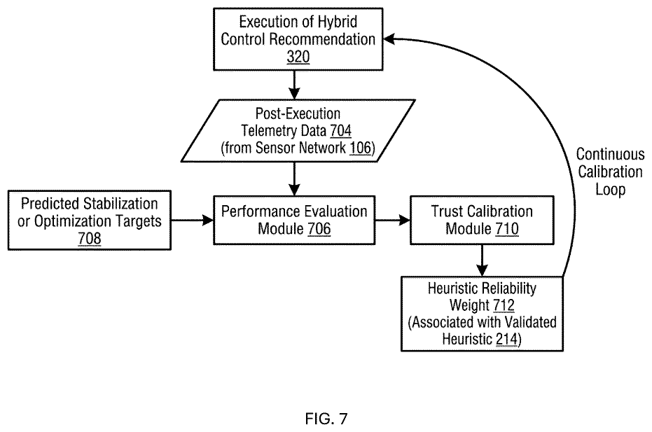

Performance-Based Trust Updating Loop (FIG. 7): Referring to FIG. 7, a performance-based trust updating loop 700 is shown. Following execution of a hybrid control recommendation 320, post-execution telemetry data 704 (derived from sensor network 106) are analyzed by a performance evaluation module 706 to assess whether predicted stabilization or optimization targets 708 have been achieved. A trust calibration module 710 updates a heuristic reliability weight 712 associated with the applied validated heuristic 214 based on measured physical outcomes, enabling continuous calibration of trust in human-derived operational knowledge.

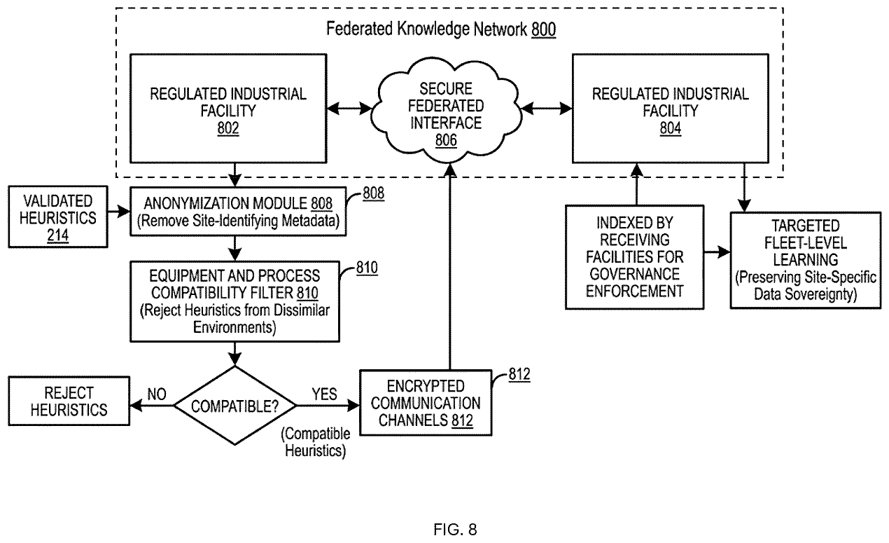

Federated Knowledge Network (FIG. 8): Referring to FIG. 8, a federated knowledge network 800 is illustrated, interconnecting a cohort of similarly configured regulated industrial facilities 802, 804 via a secure federated interface 806. Validated heuristics 214 are processed by an anonymization module 808 to remove site-identifying metadata and evaluated by an equipment and process compatibility filter 810 configured to reject heuristics derived from dissimilar operational environments. Compatible heuristics are transmitted via encrypted communication channels 812 and indexed by receiving facilities for governance enforcement, enabling targeted fleet-level learning while preserving site-specific data sovereignty.

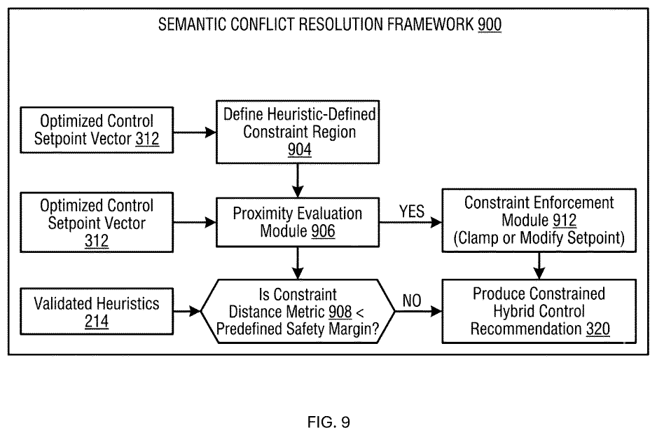

Semantic Conflict Resolution (FIG. 9): Referring to FIG. 9, a semantic conflict resolution framework 900 is illustrated. An optimized control setpoint vector 312 generated by the Predictive Optimization Engine 302 is evaluated relative to a heuristic-defined constraint region 904 derived from validated heuristics 214. A proximity evaluation module 906 computes a constraint distance metric 908 between the setpoint vector 312 and a prohibited operational boundary 910. When the distance metric falls below a predefined safety margin, a constraint enforcement module 912 clamps or modifies the setpoint, producing a constrained hybrid control recommendation 320.

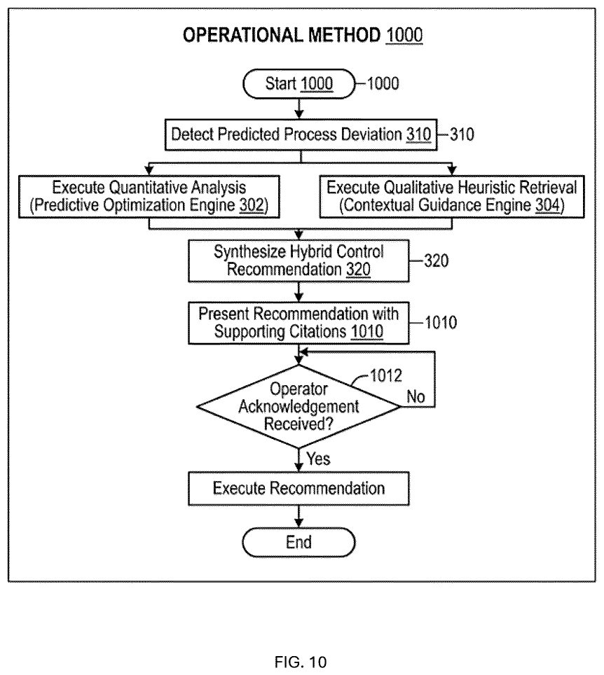

Operational Method Summary (FIG. 10): Referring to FIG. 10, a high-level operational method 1000 is illustrated. The method includes: detecting a predicted process deviation 310; executing parallel quantitative analysis via the Predictive Optimization Engine 302 and qualitative heuristic retrieval via the Contextual Guidance Engine 304; synthesizing a hybrid control recommendation 320; presenting the recommendation with supporting citations 1010; and awaiting operator acknowledgement 1012 prior to execution.

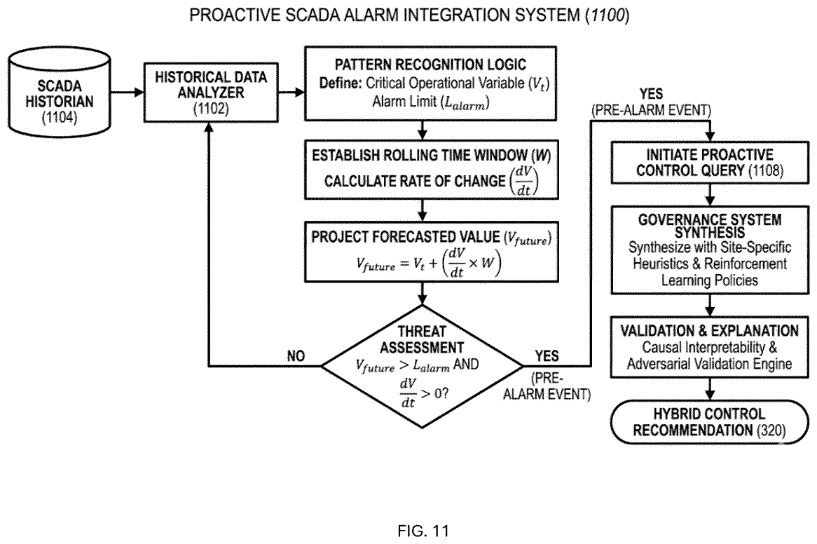

Proactive SCADA Alarm Integration (FIG. 11): Referring to FIG. 11, a proactive SCADA alarm integration system 1100 is illustrated. A historical data analyzer 1102 evaluates telemetry trends stored in a SCADA historian 1104 to identify pre-alarm patterns 1106. In operation, the analyzer executes a pattern recognition logic that first defines a critical operational variable (Vₜ) and an associated alarm limit (Lₐₗₐᵣₘ). The system establishes a rolling time window (W), such as 15 minutes, and calculates the first derivative or rate of change

$$( \frac{dV}{dt} )$$

of the variable over this window. A forecasted value (V_{future}) is then projected by extrapolating the current rate of change over the defined window, mathematically represented as

$${V}_{future} = {V}_{t} + ( \frac{dV}{dt} \times W ) .$$

If the analyzer determines that the forecasted value exceeds the alarm limit and the rate of change is positive, indicating a trajectory toward a violation, a pre-alarm event is triggered. This event automatically initiates a proactive control query 1108 supplied to the governance system. The governance system then synthesizes this query with validated site-specific heuristics and reinforcement learning policies to generate a preventive control action, embodied as a hybrid control recommendation 320. This recommendation is subjected to Causal Interpretability to explain the trajectory to the operator and is filtered by the Adversarial Validation Engine to ensure the preventive move does not violate secondary safety constraints. This integrated approach stabilizes the process prior to alarm threshold activation, reducing mechanical stress and ensuring continuous regulatory compliance.

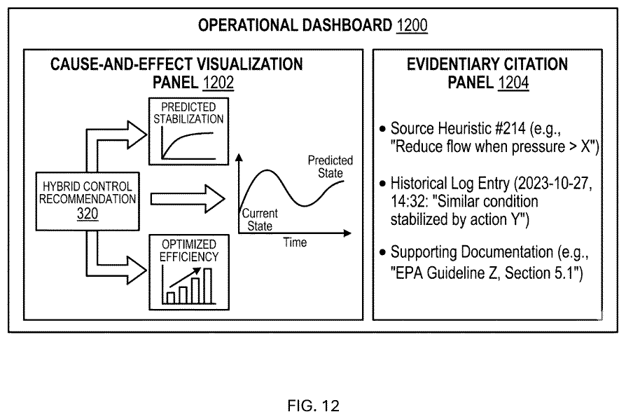

Operator Dashboard and Evidence Presentation (FIG. 12): Referring to FIG. 12, an operator dashboard 1200 is illustrated. The dashboard includes a cause-and-effect visualization panel 1202 presenting predicted outcomes of the hybrid control recommendation 320 and an evidentiary citation panel 1204 displaying source heuristics, historical logs, or documentation supporting the recommendation.

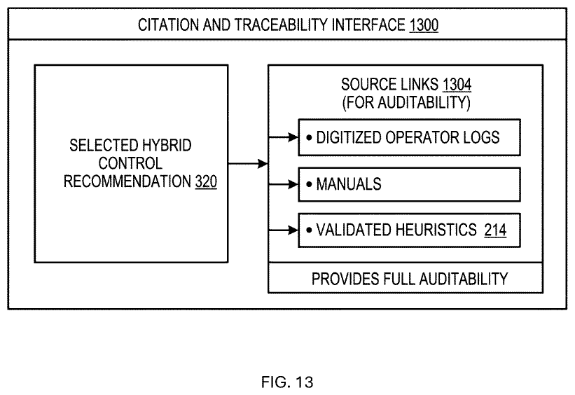

Citation and Traceability Interface (FIG. 13): Referring to FIG. 13, a citation and traceability interface 1300 is shown. Upon selection of a hybrid control recommendation 320, the interface displays source links 1304 connecting the recommendation to digitized operator logs, manuals, or validated heuristics 214, providing full auditability.

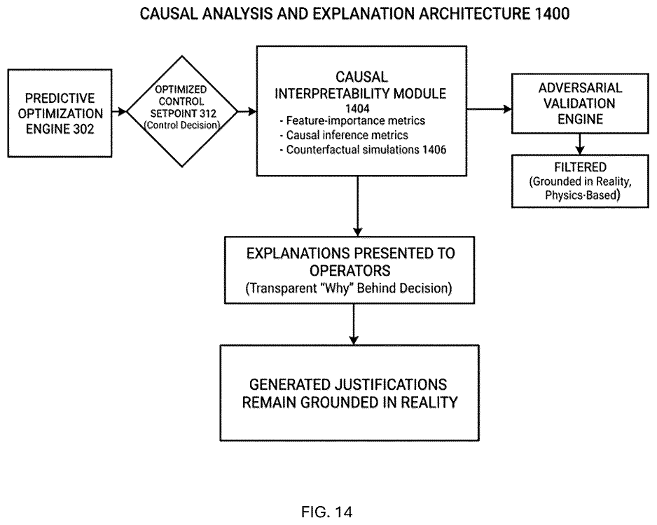

Causal Analysis and Explanation Architecture (FIG. 14): Referring to FIG. 14, a Causal Analysis and Explanation architecture 1400 is illustrated to address “black box” concerns common in AI deployments. The Predictive Optimization Engine 302 generates a control decision (optimized control setpoint 312) that is analyzed by a Causal Interpretability Module 1404. This module computes feature-importance metrics, causal inference metrics, or counterfactual simulations 1406, which are presented to operators to clarify factors influencing the decision. These explanations provide a transparent “why” behind any recommendation, linking quantitative outputs to qualitative operational logic. The Adversarial Validation Engine 210 further acts as a safeguard against hallucinations by filtering any explanation that does not align with physics-based constraints or regulatory standards, ensuring that the generated justifications remain grounded in reality.

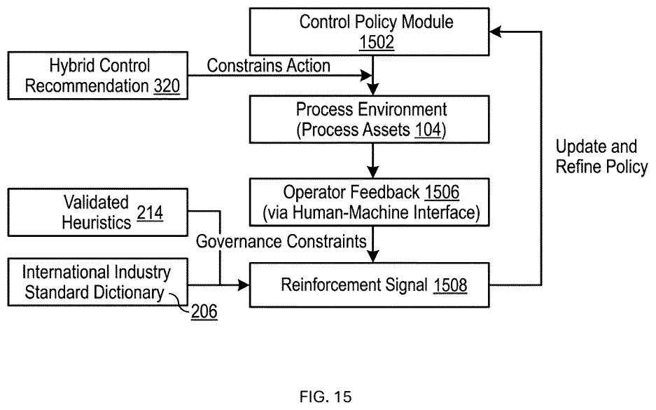

Reinforcement Learning and Operator Feedback (FIG. 15): Referring to FIG. 15, a reinforcement learning loop 1500 is illustrated to enable the system to evolve through human interaction. A control policy module 1502 proposes an action constrained by the hybrid control recommendation 320 and applied to a process environment (process assets 104). Operator feedback 1506, captured via the human-machine interface, serves as a reinforcement signal 1508 used to update and refine the control policy. Crucially, this learning process is not unconstrained; the reinforcement loop remains bounded by governance constraints enforced by validated heuristics 214 and the International Industry Standard Dictionary 206. This ensures the system improves its predictive accuracy over time while never deviating into unsafe or non-compliant operational states.

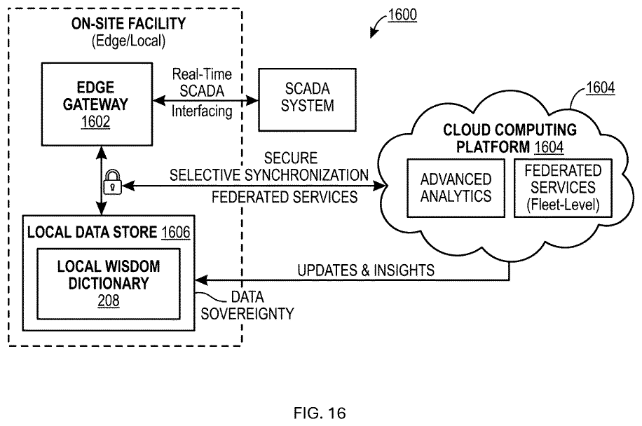

Distributed Computing and Deployment Architecture (FIG. 16): Referring to FIG. 16, a distributed computing architecture 1600 is illustrated. The architecture includes an edge gateway 1602 located on-site for real-time SCADA interfacing and a cloud computing platform 1604 hosting advanced analytics and federated services. A local data store 1606 maintains the Local Wisdom Dictionary 208, enabling data sovereignty while permitting selective synchronization with cloud-based components.

1. A computer-implemented system for governing operation of physical equipment in a regulated industrial facility, the system comprising:
(a) at least one processor operatively coupled to industrial sensors, actuators, and an industrial control system selected from a supervisory control and data acquisition (SCADA) system or a programmable logic controller (PLC);
(b) a memory storing:
(i) a regulatory knowledge base comprising machine-readable representations of safety, compliance, and operational constraints applicable to the physical equipment; and
(ii) a site-specific operational knowledge store comprising human-derived operational heuristics, each heuristic being associated with at least one asset compatibility identifier;
(c) a predictive optimization module configured to generate executable control actions for the physical equipment based on real-time sensor data; and
(d) a governance module configured to validate the operational heuristics against the regulatory knowledge base and to constrain, modify, or block transmission of executable control actions to the industrial control system when a validated heuristic indicates a safety or compliance condition, wherein constraining the executable control actions produces a physical change in operation of the equipment and prevents execution of an unsafe or non-compliant operating state.

2. The system of claim 1, wherein the governance module further comprises a contextual guidance module employing a machine learning model configured to retrieve validated heuristics via semantic retrieval and to generate non-executable semantic constraints that bound executable control actions without issuing direct control commands to the physical equipment.

3. The system of claim 1, wherein validated operational heuristics are automatically invalidated upon detection of a hardware replacement, firmware update, or configuration change of the physical equipment.

4. The system of claim 1, wherein each operational heuristic is associated with a firmware version identifier, hardware identifier, or configuration hash corresponding to the physical equipment.

5. The system of claim 1, wherein the governance module is configured to intercept, modify, or suppress control signals transmitted between the predictive optimization module and the industrial control system.

6. The system of claim 1, wherein validated operational heuristics are enforced through a machine-readable governance policy or configuration file applied to executable control actions.

7. The system of claim 1, further comprising an audit module configured to record constrained control actions together with the validated heuristics and regulatory constraints responsible for the constraint.

8. The system of claim 1, wherein validation of operational heuristics, constraint of executable control actions, and execution of constrained control actions are performed by different computing entities operating cooperatively over a network.

9. The system of claim 1, further comprising a proactive alarm integration module configured to forecast a violation of an operational limit and initiate governance-based constraint of executable control actions prior to alarm activation.

10. The system of claim 1, further comprising a federated knowledge interface configured to exchange anonymized validated heuristics between geographically distinct facilities while preserving asset compatibility constraints.

11. The system of claim 1, wherein the executable control actions govern at least one of aeration rate, chemical dosing, pump operation, valve configuration, or load balancing.

12. The system of claim 1, wherein the regulated industrial facility comprises a water treatment facility, energy production facility, chemical processing plant, or manufacturing facility.

13. A computer-implemented method for governing control of physical equipment in a regulated industrial facility, the method comprising:
(a) storing regulatory constraints and human-derived operational heuristics in a memory;
(b) generating executable control actions based on real-time sensor data;
(c) validating operational heuristics against regulatory constraints;
(d) constraining, modifying, or blocking execution of control actions when a validated heuristic indicates a safety or compliance condition; and
(e) executing constrained control actions to prevent unsafe operation of the equipment.

14. The method of claim 13, wherein constraining control actions comprises intercepting control signals prior to transmission to an industrial controller.

15. The method of claim 13, wherein validated operational heuristics are enforced via a machine-readable policy or configuration file.

16. The method of claim 13, further comprising recording constrained control actions together with causal governance data in an audit log.

17. The method of claim 13, wherein validating heuristics and executing constrained control actions are performed by different computing systems operating cooperatively over a network.

18. The method of claim 13, further comprising invalidating operational heuristics upon detection of a change in hardware, firmware, or configuration of the equipment.

19. A non-transitory computer-readable medium storing instructions that, when executed by one or more processors, cause the processors to: (a) validate human-derived operational heuristics against regulatory constraints; (b) constrain executable control actions based on validated heuristics; (c) block execution of unsafe control actions; and (d) produce a physical change in operation of industrial equipment.

20. A non-transitory computer-readable medium storing a governance policy data structure comprising: (a) a validated operational heuristic; (b) an associated asset compatibility identifier; and (c) a constraint definition applied to executable control actions.
